(19) United States
(12) Patent Application Publication
(10) Pub. No.: US 2026/0016116 A1
(43) Pub. Date: Jan. 15, 2026

(54) ADJUSTABLE CHOCK HAVING SLIDING SURFACE AND MOUNTING ASSEMBLY INCLUDING THE ADJUSTABLE CHOCK

(71) Applicant: AKTIEBOLAGET SKF, GOTEBORG (SE)

(72) Inventor: Rene VERMEULEN, Spijkenisse (NL)

(21) Appl. No.: 19/262,313

(22) Filed: Jul. 8, 2025

(30) Foreign Application Priority Data
Jul. 15, 2024 (DE) 102024206625.7

(51) Int. Cl. F16M 11/12; F16B 43/00; F16M 11/04

(52) U.S. Cl. CPC F16M 11/12; F16B 43/002; F16M 11/043

(57) ABSTRACT

An adjustable chock includes a first component having an upper bearing surface, a second component having a lower bearing surface and a through hole into which a portion of the first component extends, a bearing element having an upper surface and a lower bearing surface in contact with the upper bearing surface of the first component, and a sliding element on the upper surface of the bearing element having a lower coefficient of friction than a coefficient of friction of a material of the bearing element.

### CROSS-REFERENCE

This application claims priority to German patent application no. 10 2024 206 625.7 filed on Jul. 15, 2024, the contents of which are fully incorporated herein by reference.

### TECHNOLOGICAL FIELD

The present disclosure relates to a mounting assembly that includes an adjustable chock configured to allow limited transverse movement of an object supported by the adjustable chock.

### BACKGROUND

Some equipment is subject to important temperature and/or pressure variations that must be accounted for in the design. For example, in case of a fuel tank, it is of paramount importance to allow deformations due to variations in the pressure and/or in the temperature of the fluid in the tank. Otherwise, if such deformations are obstructed, large stresses can develop, thus reducing the structural safety margins of the equipment and the support.

Usually, at the bearing or support level, allowing such deformations is done by fixing one side of the fuel tank and letting the fuel tank slide at the opposed side. In general, a grout or an epoxy resin is used to chock the supports of such a fuel tank. Nevertheless, while the grout or the epoxy resin is curing, operational activities are limited if not forbidden in the vicinity of the grout or of the epoxy resin.

Adjustable levelling pads or chocks are easy-to-set devices that are generally configured to provide both support and vertical alignment capability with or without an associated anchor bolt. As adjustable chocks do not need curing they expedite installation compared to grout or epoxy resin alternatives.

Adjustable chocks are well known in the art. Reference can be made to FIGS. 1A and 1B which illustrate a known adjustable chock 10. The adjustable chock 10 is mounted to connect the frame 1 of a machine or equipment to a foundation or support 2, for example made of concrete or steel. Anchoring the frame 1 to the support 2 is done here with an anchor bolt 3. The adjustable chock 10 comprises a first component 11 or shaft element, a second component 12 or annular element and a third component 13 or bearing element. The first, second and third components 11, 12, 13 are coaxial along a vertical axis Z-Z′.

The first component 11 comprises an upper portion 11a and a lower portion 11b having an external thread 11c. As illustrated in FIG. 1B, the upper portion 11a has an upper surface 11d having a concave portion. The first component 11 has a through-hole 14 for accommodating a shank 3a of the bolt 3. The second component 12 has a second through-hole 12a having an internal thread 12b configured to engage with the external thread 11c of the first component 11. The threaded portions 11c, 12b cooperate with each other and provide allow for vertical adjustment between the first component 11 and the second component 12. The third component 13 sits between the frame 1 and the upper portion 11a of the first component 11.

As shown in FIG. 1B, the third component 13 has a lower surface 13a engaging with the upper surface 11d of the first component 11. The lower surface 13a and the upper surface 11d are complementarily shaped so as to facilitate slight adjustment of the positions between the first component 11 and the third component 13 relative to one another, for example, in order to accommodate slight deviations from the frame 1 of the machine and the support 2.

The third component 13 has a through hole 16 having a diameter larger than the diameter of the first through-hole 14 in order to allow the shank 3a of the bolt 3 to pass through if an axis of symmetry of the lower surface 11d of the first component 11 is not aligned with an axis of symmetry of the lower surface 13a of the third component 13. This allows for the accommodation of deviations from horizontal, parallel orientations of the frame 1 of the machine and the support 2.

The chock 10 is sandwiched between the frame 1 of the machine and the support 2 and securely held in place by the bolt 3 and a nut 4 screwed on a part of the shank 3a extending beyond the frame 1 of the machine. The height of the adjustable chock 10 is adjusted by screwing the first component 11 further into or further out of the second component 12. When installed, the chock 10 is subjected to the weight load of the frame 1 of the machine, and, more generally, to reaction forces transmitted by the support 2 and/or by the frame 1. The axial stiffness of an adjustable chock 10 depends on the axial load capacity and its transverse stiffness depends on the transverse load capacity. However, known adjustable chocks do not allow sliding of the supported equipment and so they cannot be used for allowing deformations of the supported equipment. It would therefore be desirable to provide an adjustable chock that allows sliding of the supported equipment.

### SUMMARY

The disclosure relates to a kit comprising an adjustable chock provided with a first component, with a second component, and with a bearing element. The second component is secured onto an outer surface of the first component and has a lower bearing surface. The bearing element has a lower bearing surface in contact with an upper bearing surface of the first component, and with an upper bearing surface.

The kit further comprises a sliding element provided on the upper bearing surface of the bearing element and having a lower friction coefficient than the upper bearing surface of the bearing element. Such a kit forms an easy-to-set levelling device that expedites installation time as no curing is needed. The sliding element facilitates sliding by reducing friction.

In one embodiment, the sliding element is a coating provided on the upper bearing surface of the bearing element. In one embodiment, the sliding element is a washer mounted on the upper bearing surface of the bearing element. For example, the kit further comprises a stainless-steel plate sitting on the sliding element. The stainless-steel plate reduces friction and protects the sliding element. In one embodiment, the surface of the stainless-steel plate that is in contact with the sliding element has a roughness average Ra less than 0.8 μm.

The first component and the second component are provided respectively with a first and a second through-hole, the kit including a rod having an external thread, the rod extending through the through-holes. The rod has a first end and a longitudinally opposite second opposite end which delimit the axial length of the rod and which are axially located on one side of the bearing element. The first through-hole of the first component has an internal thread cooperating with the external thread of the rod.

Preferably, the kit comprises a bottom nut mounted on the first end of the rod, the bottom nut being fixed by a tightening torque. Such a kit can easily be secured to a support with the help of the rod and the bottom nut. The value of the tightening torque is selected so as to reliably secure the adjustable chock to the support.

The disclosure also relates to an assembly comprising the kit as previously defined. The assembly further comprises a frame and a support provided with a third through-hole. The rod of the kit is mounted in the through-holes, the adjustable chock being sandwiched between the support and the frame. Preferably, the support has anti-uplifting means of the frame.

The disclosure also relates to an adjustable chock comprising a first component having an upper bearing surface, a second component having a lower bearing surface and a through hole into which a portion of the first component extends, a bearing element having an upper surface and a lower bearing surface in contact with the upper bearing surface of the first component, and sliding means on the upper surface of the bearing element having a lower coefficient of friction than a coefficient of friction of a material of the bearing element.

In one embodiment, the anti-uplifting means comprise at least a hook provided with a rod having a contact surface configured to contact a top surface of the frame. Advantageously, the rod may have an outer thread, the assembly comprising at least one nut mounted on a first end of the rod such that a predetermined distance between the frame and the contact surface can be set. For example, the rod may comprise releasable locking means preventing relative displacement and/or relative rotation between the nut and the rod.

### BRIEF DESCRIPTION OF THE DRAWINGS

The present disclosure and its advantages will be better understood by studying the detailed description of specific embodiments given by way of a non-limiting examples and illustrated by the appended drawing on which:

FIG. 1A is a perspective view of a conventional adjustable chock.

FIG. 1B is a side elevational view of the adjustable chock of FIG. 1A, partly in section, mounted between a support and an object being supported.

FIG. 2 is a sectional side elevational view of a kit according to an embodiment of the present disclosure mounted between a support and an object being supported.

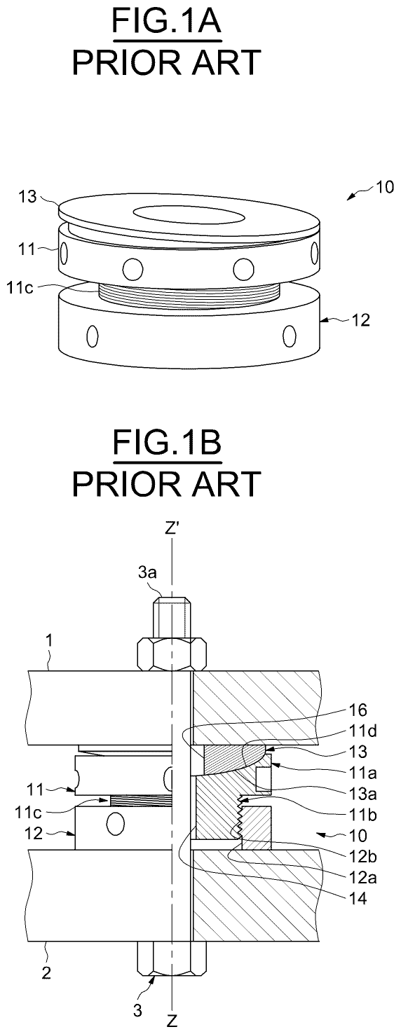

### DETAILED DESCRIPTION

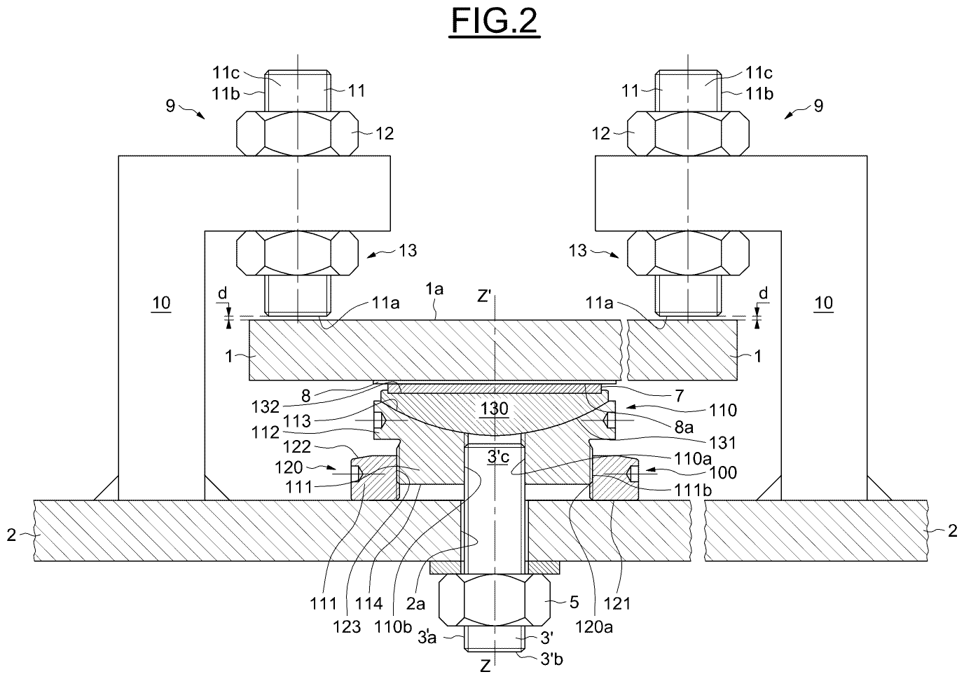

As shown in FIG. 2, the kit comprises an adjustable chock 100 mounted to connect a frame 1 of an equipment or a machine to a foundation or support 2. Anchoring the kit to the support 2 is done here with a rod 3′ having an external thread 3′a. Alternatively, it is possible to secure the kit to the support 2 with different fixing means, commonly known to the skilled person. For example, the kit can be secured by welding or by screwing.

The adjustable chock 100 comprises a first component 110 or shaft element, a second component 120 or lower adjustable part and a third component or bearing element 130. The first, second and third components 110, 120, 130 are coaxial along a vertical axis Z-Z′. The chock 100 is symmetric relative to the longitudinal axis Z-Z′. The first, second and third components 110, 120, 130 are made, for example, of steel, preferably high-grade steel.

As illustrated in FIG. 2, the first component 110, the second component 120 and the bearing element 130 are sandwiched between the support 2 and the frame 1.

In the example shown in FIG. 2, the first component 110 of the adjustable chock comprises a lower portion 111 and an upper flange 112. The first component 110 has an external thread 111b. The external thread 111b is formed on the outer surface of the lower portion 111. The upper flange 112 protrudes radially outwards with respect to the lower portion 111. The upper flange 112 has an upper bearing surface 113 with a concave portion. The upper surface 113 is rotationally symmetric. The upper surface 113 forms the upper surface of the first component 110.

The first component 110 has a first through-hole 110a extending axially from the upper surface 113 to a lower surface 114 of the first component 110. The first through-hole 110a has an internal thread 110b cooperating with the external thread 3′a of the rod 3′. For example, the rod 3′ may comprise a shank and at least one external thread portion forming the external thread 3′a. The external thread 3′a may comprise several threaded portions spaced axially from each other. Alternatively, the rod 3′ may be a full threaded rod. In one other example, the rod 3′ may be a bolt.

The second component 120 of the adjustable chock has a lower bearing surface 121 and an upper surface 122 that axially delimit the second component 120. The lower surface 121 is axially opposite to the upper surface 122. The upper surface 122 is located axially on the side of the upper flange 112 of the first component. The second component 120 has a second through-hole 120a extending axially from the upper surface 122 to the lower surface 121. The second through-hole 120a has an internal thread 123 configured to engage with the external thread 111b of the first component 110. The threads 111b, 123 cooperate together and provide a vertical adjustment.

The first component 110 is movable with respect to the second component 120 between a partially screwed position, shown in FIG. 2, in which the threads 111b of the first component 110 partially cooperate with the threads 123 of the second component 120 and a fully screwed position, not shown, in which the lower surface of the upper flange 112 of the first component axially abuts against the upper surface 122 of the second component.

The bearing element 130 of the adjustable chock sits on the upper flange 112 of the first component 110. The bearing element 130 has a lower bearing surface 131 and an upper bearing surface 132. The lower surface 131 is axially opposite to the upper surface 132. The lower surface 131 is in contact with the upper surface 113 of the first component. The lower surface 131 has a convex shape and is rotationally symmetric.

The lower surface 131 and the upper surface 113 are complementarily shaped so as to facilitate slight adjustment of the positions between the first component 110 and the bearing element 130 relative to one another, for example, in order to accommodate slight deviations from the frame 1 and the support 2. The radius of curvature of the lower surface 131 of the bearing element 130 corresponds to the radius of curvature of the upper surface 113 of the first component 110. In the illustrated example, the upper bearing surface 132 of the bearing element 130 extends radially.

In the described example, the bearing element 130 is made, for example, of steel. Alternatively, the bearing element 130 may be made of a low friction material, for example a metal with a solid lubricant such as PTFE.

In the exemplary embodiment shown in FIG. 2, the kit comprises a bottom nut 5 mounted on a first end 3′b of the rod 3′. The rod 3′ extends between the first end 3′b and a second opposite end 3′c. The first end 3′b and the second opposite end 3′c delimit the axial length of the rod 3′. The bottom nut 5 is fixed by a tightening torque that allows pulling the first component 110 towards the support 2 through the rod 3′, and thus secures the kit onto the support 2. It should be noted that this is made possible by the mutual engagement of the threads 110b and 3′a. As shown in FIG. 2, the support 2 has a third through-hole 2a. The rod 3′ extends through the first, the second and the third through-holes 110a, 120a, 2a.

In order to free up the sliding of the frame 1, the kit comprises a sliding element 7 provided on the upper bearing surface 132 of the bearing element 130. The sliding element 7 is made of a material having a lower friction coefficient than the upper bearing surface 132 of the bearing element 130. Such a material comprises at least partly a metal (for example Ag, Sn, Cu) and/or a solid lubricant such as PTFE.

For example, the sliding element 7 may comprise a plate or a washer mounted on the upper bearing surface 132 and/or may comprise a coating provided on the upper bearing surface 132.

As shown in FIG. 2, the kit may further comprise a stainless-steel plate 8 sitting on the sliding element 7, especially if the roughness of the surface of the frame 1 is relatively high. However, the stainless-steel plate 8 may not be necessary in case the surface of the frame 1 is relatively smooth, typically having an average roughness Ra less than 0.8 μm. For example, the surface 8a of the stainless-steel plate 8 that is in contact with the sliding element 7 has an average roughness Ra less than 0.8 μm.

Preferably, the support 2 has anti-uplifting means 9 of the frame 1. The anti-uplifting means 9 prevent the uplift of the frame 1 from the support 2. As shown in FIG. 2, the anti-uplifting means 9 comprise at least a hook 10 provided with a rod 11 having a contact surface 11a configured to contact a top surface 1a of the frame 1. The uplift is prevented as the top surface 1a of the frame 1 abuts against the contact surface 11a.

Preferably, the hook 10 is rigidly fixed to the support 2. Alternatively, the hook 10 may be provided with translational guidance means over the support 2.

In one embodiment, the rod 11 has an outer thread 11b and a nut 12 is mounted on a first end 11c of the rod 11 such that a predetermined distance “d” between the frame 1 and the contact surface 11a can be set.

Advantageously, the rod 11 may comprise releasable locking means 13 that prevent relative displacement and/or relative rotation between the nut 12 and the rod 11. The releasable locking means 13 are activated once the predetermined distance “d” has been set, in order to prevent relative displacement and/or relative rotation between the nut 12 and the rod 11. For example, the releasable locking means 13 may comprise a pin or a nut.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved adjustable chocks.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. An adjustable chock comprising:
a first component having an upper bearing surface,
a second component having a lower bearing surface and a through hole into which a portion of the first component extends,
a bearing element having an upper surface and a lower bearing surface in contact with the upper bearing surface of the first component, and
sliding means on the upper surface of the bearing element having a lower coefficient of friction than a coefficient of friction of a material of the bearing element.

2. The adjustable chock according to claim 1,
wherein the first portion of the first component includes an external thread, and
wherein the through hole of the second component includes an internal thread in engagement with the external thread of the first portion of the first component.

3. The adjustable chock according to claim 2,
wherein the upper bearing surface of the first component includes a concavity and wherein the lower bearing surface of the bearing element is convex, and
wherein the bearing element closes an upper end of the through hole of the second component.

4. The adjustable chock according to claim 3,
wherein the sliding means comprises a coating on the upper surface of the bearing element.

5. The adjustable chock according to claim 3,
wherein the sliding means comprises a washer mounted on the upper surface of the bearing element.

6. The adjustable chock according to claim 5,
wherein the upper surface of the bearing element includes a depression, and
wherein the washer is mounted in the depression.

7. The adjustable chock according to claim 5,
wherein the washer comprises a solid lubricant.

8. The adjustable chock according to claim 7,
including a steel plate on the washer.

9. The adjustable chock according to claim 8,
wherein a surface of the steel plate in contact with the washer has an average surface roughness less than 0.8 μm.

10. The adjustable chock according to claim 5,
wherein the first component includes a threaded through hole.

11. An assembly comprising:
an adjustable chock according to claim 10, and
a rod having an external thread engaged with an internal thread of the threaded through hole of the first component,
wherein the rod had a first end and a second end spaced from the first end, and
wherein the first end and the second end of the rod are located on a same side of the bearing element.

12. A system comprising:
a frame,
a support, and
an assembly according to claim 11 mounted between the frame and the support with lower bearing surface of the second component in contact with an upper surface of the support and the sliding means in contact with the frame,
wherein the support includes a through opening,
wherein the rod extends through the through opening, and
wherein a nut is mounted on the second end of the rod and tightened against a bottom surface of the support with a first tightening torque.

13. The adjustable chock according to claim 8,
wherein the first component includes a threaded through hole.

14. An assembly comprising:
an adjustable chock according to claim 13, and
a rod having an external thread engaged with an internal thread of the threaded through hole of the first component,
wherein the rod had a first end and a second end spaced from the first end, and
wherein the first end and the second end of the rod are located on a same side of the bearing element.

15. A system comprising:
a frame,
a support, and
an assembly according to claim 14 mounted between the frame and the support with lower bearing surface of the second component in contact with an upper surface of the support and the sliding means in contact with the frame,
wherein the support includes a through opening,
wherein the rod extends through the through opening, and
wherein a nut is mounted on the second end of the rod and tightened against a bottom surface of the support with a first tightening torque.

16. The assembly according to claim 15,
including anti-uplifting means on the support for holding the frame against the adjustable chock.

17. The assembly according to claim 16,
wherein the anti-uplifting means comprise a hook having a first end connected to the support and a second end projecting over a portion of the frame, the second portion including a through hole,
wherein a rod extends through the through hole and includes a first end on a side of the second portion opposite the frame and a second end in contact with the frame, and
wherein a nut secures the rod relative to the second portion.
